(19) United States
(12) Patent Application Publication
(10) Pub. No.: US 2024/0237664 A1
(43) Pub. Date: Jul. 18, 2024

(54) METHOD AND APPARATUS FOR MAKING YOGURT

(71) Applicant: Timothy M. Londergan, Seattle, WA (US)

(72) Inventor: Timothy M. Londergan, Seattle, WA (US)

(73) Assignee: DOS CENTAVOS, LLC, EVERETT, WA (US)

(21) Appl. No.: 18/422,862

(22) Filed: Jan. 25, 2024

Related U.S. Application Data
(63) Continuation-in-part of application No. 17/652,228, filed on Feb. 23, 2022, now abandoned.
(60) Provisional application No. 63/153,342, filed on Feb. 24, 2021.

(51) Int. Cl. A23C 9/123; A23C 3/03; A23C 9/12

(52) U.S. Cl. CPC A23C 9/123; A23C 3/03; A23C 9/122

(57) ABSTRACT

A method including sonication of a yogurt culture produces desirable texture and yield characteristics. An apparatus for producing yogurt from milk includes a sonicator for controlling texture.

### CROSS REFERENCE TO RELATED APPLICATIONS

The present application is a Continuation-in-Part of U.S. patent application Ser. No. 17/652,228, entitled “METHOD AND APPARATUS FOR MAKING YOGURT,” filed Feb. 23, 2022 (docket number 3034-017-03) which claims priority benefit from U.S. Provisional Patent Application No. 63/153,342, entitled “METHOD AND APPARATUS FOR MAKING YOGURT,” filed Feb. 24, 2021 (docket number 3071-001-02), and, to the extent not inconsistent with the disclosure herein, are incorporated by reference.

### SUMMARY

According to an embodiment, a method for making yogurt includes sonicating a yogurt precursor early in a fermentation period. According to an embodiment, a method for making yogurt includes sonicating a yogurt or yogurt precursor late in the fermentation period. According to an embodiment, a method for making yogurt includes sonicating a yogurt precursor according to a pulse schedule including at least two sonication periods separated by a quiescent period before half of a total fermentation duration elapses. Sonication is understood in the industry as being synonymous with ultrasonication, i.e., treatment at frequencies that exceed the audible frequency range for normal human hearing. It is with this meaning that the term is used herein. A pulsed sonication (AKA ultrasonication) schedule was found to enhance consistency of a yogurt product by increasing the viscosity to approximate that of a “Greek-style” yogurt. According to an embodiment, a method for making yogurt includes applying at least two sonication periods separated by a quiescent period early in a fermentation duration, holding the yogurt precursor quiescent for at least half the fermentation duration after the last of the early sonication periods, and applying one or more sonication periods late in the fermentation duration.

According to an embodiment, a sonication period is applied to a batch of yogurt late in a fermentation step. This “late fermentation” sonication was found to increase product yield by causing a relatively long lasting uptake of whey into curds of the fermenting yogurt.

According to an embodiment, an apparatus for making yogurt includes a fermentation vessel configured to receive a liquid milk product and a live culture for fermenting a yogurt precursor, and a sonicator configured to sonicate the yogurt precursor early, late, or early and late in a fermentation period.

### BRIEF DESCRIPTION OF THE DRAWINGS

FIG. 1A is a flowchart showing a method for making yogurt, according to an embodiment.

FIG. 1B is a flowchart showing a method for making yogurt, according to another embodiment.

FIG. 2 is a diagram of an apparatus for making yogurt, according to an embodiment.

FIG. 3 is a graph showing a schedule for sonication used in the methods of FIGS. 1 and 2, and used by the apparatus of FIG. 2, according to embodiments.

FIG. 4 is a photograph showing yogurt batches made according to three different approaches for making the yogurt; two examples corresponding to the methods of FIGS. 1 and 2, and one example corresponding to a control batch with no sonication, according to embodiments.

FIG. 5 is a partial front elevation image of a sonicator (i.e., ultrasonicator) used by the inventor during discovery of the invention.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

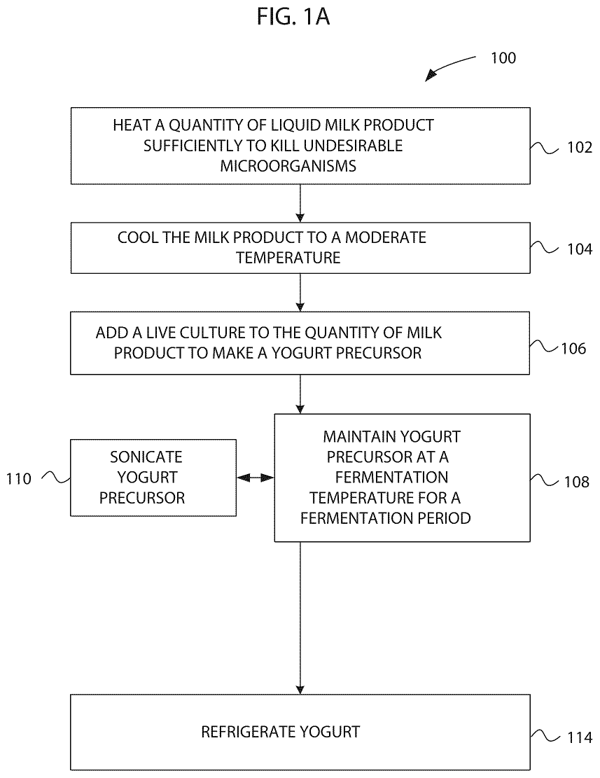

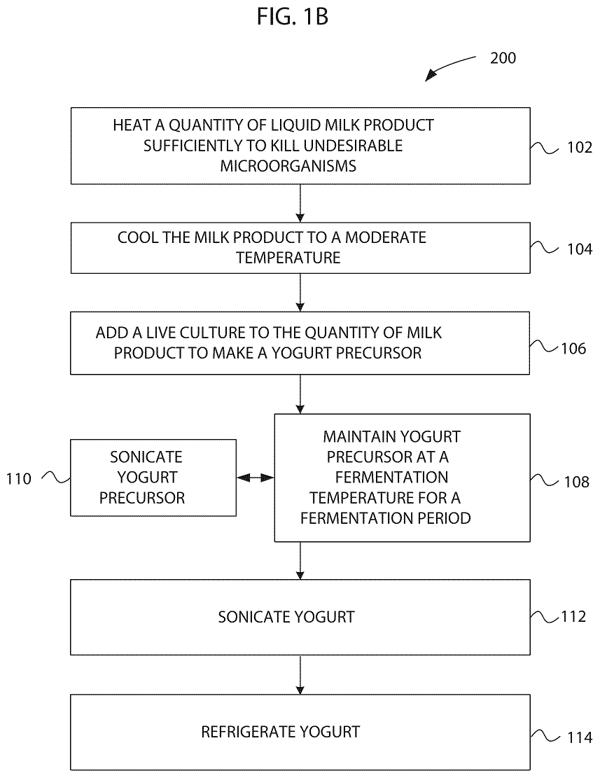

FIG. 1A is a flowchart showing a method 100 for making yogurt, according to an embodiment. According to an embodiment, a method for making yogurt includes a step 108 in which the yogurt precursor is maintained at a fermentation temperature (generally, a temperature between about 100° F. and 120° F.) during a fermentation period and a step 110 in which the yogurt precursor is sonicated according to a predetermined schedule to produce a yogurt having an improved consistency. In an embodiment, the method 100 may include step 106, in which a live culture is added to a quantity of milk product to make a yogurt precursor.

According to embodiments, step 108 is performed while the yogurt precursor is maintained at the fermentation temperature, shown as step 110. Optionally, temperature may cease to be controlled while the process executes step 108.

According to an embodiment, the yogurt is refrigerated in a step 112. According to an embodiment, the step 112 may include refrigerating the yogurt after a total fermentation period of 12 to 18 hours. According to an embodiment, the step 112 may include refrigerating the yogurt after a total fermentation period of 15 to 16 hours.

According to an embodiment, the step in which the yogurt precursor is maintained at a fermentation temperature during the fermentation period includes maintaining the yogurt precursor at a temperature of approximately (i.e., about) 110° F.

According to an embodiment, the method 100 may include a preceding step 104 in which, prior to adding the live culture, the milk product is heated to an elevated temperature, and, thereafter, the elevated temperature is reduced, and the predetermined fermentation temperature is maintained.

According to an embodiment, in the step 104, the milk product being heated to the elevated temperature may include the milk product being heated to within 20° F. of a boiling temperature.

According to an embodiment, in the step 104, the milk product being heated to within 20° F. of a boiling temperature may include the milk product being heated to 200° F.

According to an embodiment, in the step 104, the milk product being heated to the elevated temperature may include the milk product being heated to a peak temperature below a full rolling boil temperature.

According to an embodiment, the method 100 for making yogurt may include a step 102 in which the milk product is introduced to a fermentation vessel.

According to an embodiment, the step in which the milk product is introduced into a fermentation vessel may include a further step in which whole milk is introduced into the fermentation vessel.

According to an embodiment, the step in which the milk product is introduced into a fermentation vessel may include a further step in which 2% milk is introduced into the fermentation vessel.

According to an embodiment, the step in which the milk product is introduced into a fermentation vessel may include a further step in which liquid milk and a quantity of powdered milk are introduced into the fermentation vessel.

According to an embodiment, the step in which the yogurt precursor is maintained at a fermentation temperature may further include the yogurt precursor being maintained at a controlled temperature.

According to an embodiment, the step in which the yogurt precursor is maintained at a controlled temperature may include maintaining the yogurt precursor at approximately 110° F.

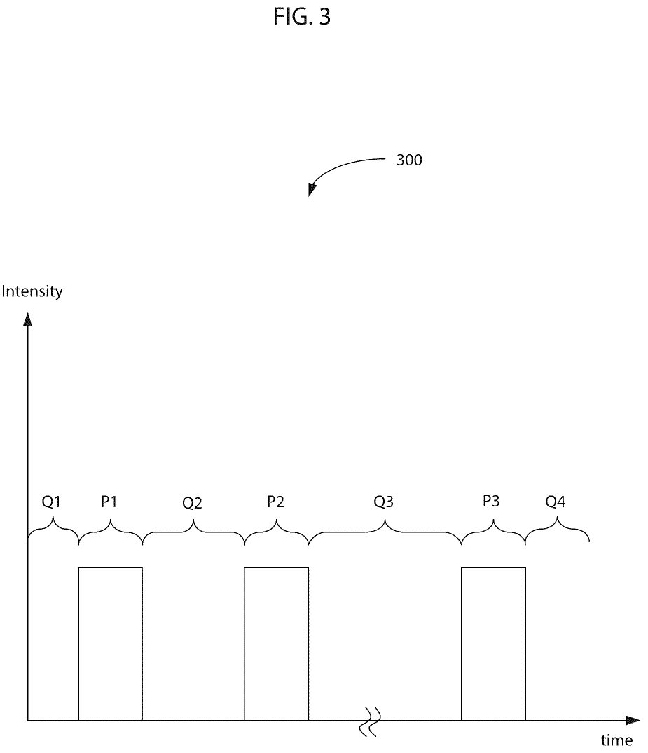

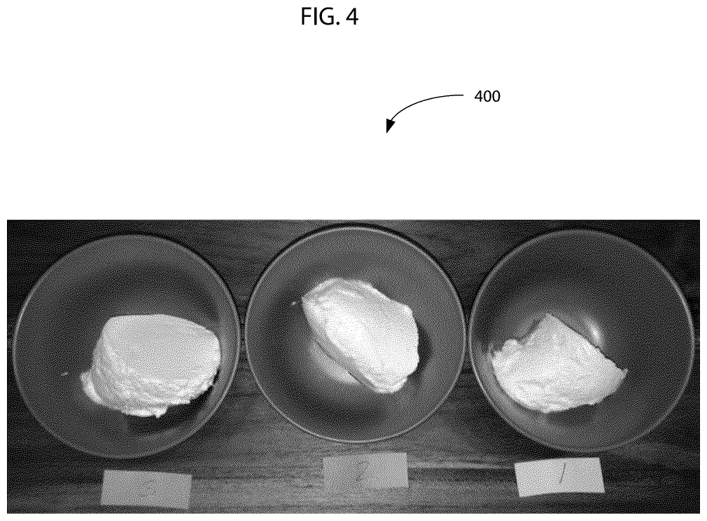

Referring to FIG. 3, which shows a schedule for sonication 300, according to an embodiment, an experimental run including no preliminary quiescent period Q1, a first sonication period P1 of 60 minutes, a second quiescent period Q2 of 30 minutes, a second sonication period P2 of 30 minutes, and a long quiescent period Q3 of 15 hours, 50 minutes (with no third sonication period) was found to yield a “Greek-style” yogurt having superior (thicker) consistency compared to a control run with no sonication. Referring to FIG. 4, the control run yielded a yogurt shown in sample 1, which exhibited normal yogurt style and thickness, with some graininess. Again referring to FIG. 4, the yogurt shown in sample 3, produced per the method described above, yielded a “Greek-style” yogurt that was firm but airy.

FIG. 1B is a flowchart showing a method 100 for making yogurt, according to an embodiment. As shown in FIG. 1B, the method 100 may include another sonication step 112, in which the fermented yogurt precursor, which may also be referred to as yogurt, is sonicated at or near an end of the fermentation step 108.

During an experimental run in which the sonication step(s) 110 was omitted, the sonication step 112 was found to release whey from the yogurt.

In contrast, performing the method 100 including the sonication step(s) 110 and the sonication step 112 shown in FIG. 1B, performing the sonication step 112 was found to cause uptake of whey into the yogurt, thus increasing yield. The uptake was found to be persistent during a shelf life of the yogurt. This may be particularly beneficial in the commercial production of yogurt, inasmuch as known processes for producing Greek yogurt include removal of much of the whey that is normally present, in order to make the yogurt more firm, but reducing the yield volume. Instead, the method 100 provides a process for producing yogurt with the desired firmness while maintaining and even increasing the yield volume and perhaps reducing waste volume. The yogurt produced can therefore be described as enhanced, relative to standard yogurt, because of the more desirable consistency, and/or relative to Greek yogurt, because of the greater yield.

Referring again to FIG. 3, an experimental run including no preliminary quiescent period Q1, a first sonication period P1 of 60 minutes, a second quiescent period Q2 of 30 minutes, a second sonication period P2 of 30 minutes, and a third quiescent period Q3 of 9 hours, 30 minutes, a third sonication period applied during a step 112 (FIG. 1B) of 30 minutes, and a fourth quiescent period Q4 of 5 hours, 20 minutes was found to yield a “Greek-style” yogurt having a most firm and creamy consistency. A photo 400 of the yogurt produced per the method of FIG. 1B is shown as sample 2 in FIG. 4.

FIG. 3 illustrates a pulse intensity versus time graph of sonication pulse periods and the quiescent periods between the pulse periods in the method step 110, wherein the yogurt precursor is sonicated according to a predetermined schedule. Shown are illustrative pulse periods P1, P2, and P3, during each of which sonication at a sonication frequency is, applied to the yogurt precursor. Additional or fewer pulse periods may be used. According to an embodiment, sonication may be applied during at least one and preferably two pulse periods (e.g., P1 and P2). The duration of each pulse period may be the same or may be different, as driven by the pre-determined schedule. Pulse periods P1, P2 may be separated by at least one quiescent period Q1 lacking sonication and having a duration of quiescence (quiescent duration) indicated in FIG. 3 by the horizontal (time-axis) distance between P1 and P2.

According to an embodiment, the series of at least two pulse periods P1, P2, P3 . . . being applied may include a first pulse period P1 having first pulse-period duration D1 of about 1 hour. The first pulse period P1 may start when the live culture is added, or up to an hour after the live culture is added. According to an embodiment, the quiescent duration of the first quiescent period Q1 may include an interval of between 15 minutes and two hours. For example, the first quiescent period Q1 may be between 20 minutes and one hour. In another example, the first quiescent period Q1 may be a half hour. According to an embodiment, the sonication 110 may include applying, after the end of the first quiescent period Q1, a second pulse period P2 having a second pulse-period duration D2. The second pulse period P2 duration may have a duration D2 of between a quarter hour and one-and-one-half hours. For example, the second pulse period P2 may have a duration D2 of a half hour.

According to an embodiment, the series of at least two pulse periods being applied may further include a step, performed after the second pulse period P2, of applying a third pulse period P3 having a third pulse-period duration D3 of about one hour. The third pulse period may follow a second quiescent period Q2 having a second quiescent duration of between six and twelve hours.

According to an embodiment, applying a pulse period later during fermentation was found to cause uptake of whey into the yogurt and to increase consistency of the yogurt to a consistency corresponding to a Greek yogurt.

According to an embodiment, a third quiescent period Q3 of between two and eight hours may be maintained after the third pulse period.

Pulse periods of sonication may define pulse envelopes that are rectangular as illustrated or that have other envelope shapes.

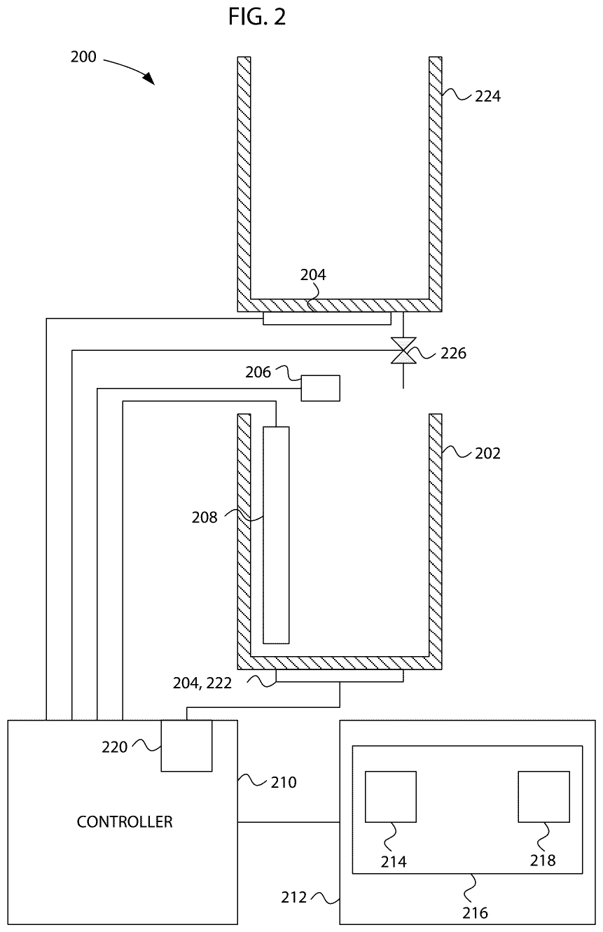

According to an embodiment, FIG. 2 illustrates an apparatus for making yogurt 200 including a fermentation vessel 202 configured to receive a milk product, a live culture dispenser 206 configured to dispense a live culture into the milk product to make a yogurt precursor, and a sonicator 208 configured to sonicate the yogurt precursor according to a predetermined schedule.

According to an embodiment, the apparatus for making yogurt 200 may include a heater 204 configured to heat the milk product to an elevated temperature. According to an embodiment, the apparatus for making yogurt 200 may include an electronic controller 210 operatively coupled to the sonicator 208, the electronic controller 210 being configured to cause the sonicator 208 to operate according to sensor (not shown) feedback or according to a predetermined schedule.

The apparatus for making yogurt 200 may include a human interface 212 operatively coupled to the electronic controller, the human interface 212 being configured to receive at least a command to start a yogurt making process 100. According to an embodiment, the human interface 212 may includes a touch screen 216. According to an embodiment, the human interface 212 may include a first control 214 to receive a command of a selection of a yogurt consistency. According to an embodiment, the electronic controller 210 may select the predetermined schedule according to a selection of a yogurt consistency. According to an embodiment, the human interface 212 may include a second control 218 to receive a specification of a characteristic of the milk product. The electronic controller 210 may be configured to select the predetermined schedule based in part on the specification of the characteristic of the milk product. According to an embodiment, the electronic controller 210 may select a predetermined schedule including a relatively large amount of sonication early in a yogurt making process when the electronic controller is set to a “Greek style” yogurt.

According to an embodiment, the apparatus for making yogurt of claim 20 may further include a thermostatic control 220 to maintain a fermentation temperature in the fermentation vessel 202 during a yogurt making process. According to an embodiment, the apparatus for making yogurt 200 may include a cooler 222 configured to refrigerate yogurt in the fermentation vessel 202 upon conclusion of a yogurt making process. For example, the apparatus for making yogurt 200 may include a Peltier Effect cooler configured to selectively heat or cool the fermentation vessel 202 according to the predetermined temperature schedule.

According to an embodiment, the apparatus for making yogurt 200 may include a separate heater configured to heat the milk product to an elevated temperature in a heating vessel 224 prior to introduction of the milk product into the fermentation vessel 202, and may further include a milk product dispenser 226 configured to transfer the milk product at the elevated temperature into the fermentation vessel 202 (after a cycle to elevate the temperature of the milk product). According to an embodiment, the live culture dispenser 206 may be configured to operate by flowing the milk product through the live culture dispenser 206 to mix the live culture with the milk product during transfer of the milk product into the fermentation vessel 202, such that the milk product dissolves or suspends the live culture.

According to an embodiment, the apparatus for making yogurt 200 may further include a heater 204 configured to heat the milk product to an elevated temperature in the fermentation vessel 202 prior to introduction of the live culture.

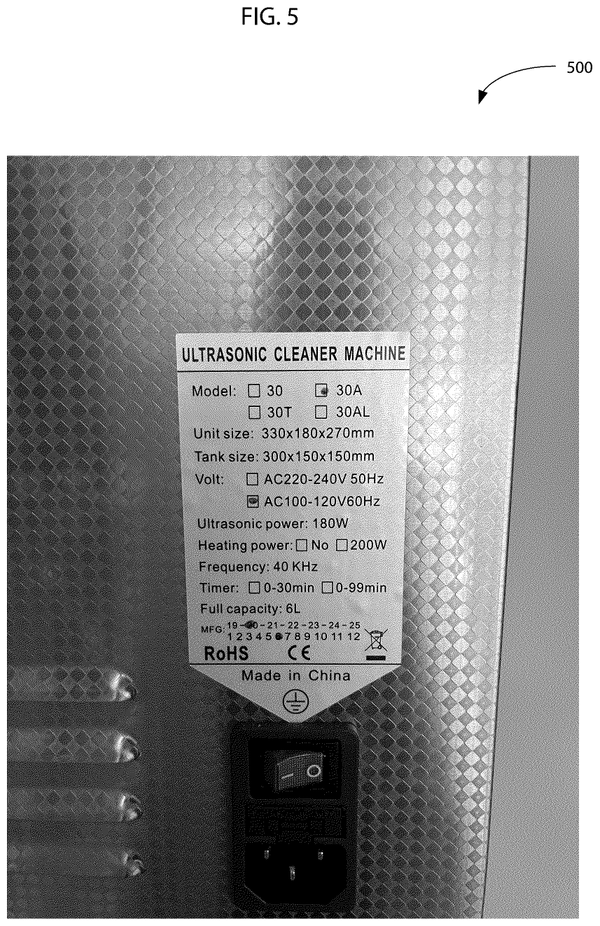

FIG. 5 is a partial front elevation image of an ultrasonic cleaner machine 500 of a type used by the inventor to perform experiments and tests during the discovery and development of the principles disclosed herein. The ultrasonic cleaner machine 500 was used to sonicate yogurt precursor samples in accordance with embodiments and experimental runs described above. As shown in the figure, the cleaner machine 500 is configured to operate at the ultrasonic frequency of 40 kHz, although other embodiments are envisioned in which sonication is performed at other ultrasonic frequencies.

As is well understood in the industrial arts, ultrasonic cleaner machines of the type shown in FIG. 5 typically include a stainless steel tank in which a quantity of cleaning fluid, as a transmission medium, and objects to be cleaned are deposited. The machines are configured to apply ultrasonic pulses, via transducers coupled to an outer surface of the tank, to the fluid and objects within the tank, in order to clean the objects. Such machines may also include heating elements affixed to the outer surface of the tank in order to heat the fluid during the cleaning process.

As can be seen in FIG. 5, the ultrasonic cleaner machine 500 includes a tank with a capacity of about 6.75 liters (300×150×150 mm) and an ultrasonic output of 40 KHz.

According to an embodiment, an ultrasonic cleaner machine may be employed to produce yogurt in accordance with other embodiments disclosed above. The tank of the machine 500 may function as a fermentation vessel and/or heating vessel similar to the fermentation and heating vessels 202, 224 described above with reference to FIG. 2, with the ultrasonic transducer and heating element of the ultrasonic cleaner machine functioning as the sonicator and heater 204, respectively. Of course, the inventor also envisions embodiments in which systems are configured to produce yogurt in volumes suitable for commercial processes. According to various embodiments, such systems may be in any appropriate configuration, including systems similar in structure to the apparatus for making yogurt 200 of FIG. 2, or the ultrasonic cleaning machine 500 of FIG. 5.

The usual and ordinary meaning of sonication (also sometimes termed ultrasonication) and related terms refers to systems or processes that operate at ultrasonic frequencies, i.e., above 20 kHz, the frequency commonly used to define the maximum audible frequency for normal human hearing.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A method for making yogurt, the method comprising:
maintaining a yogurt precursor including a liquid milk product and a live culture at a fermentation temperature during a fermentation period; and
during the fermentation period, sonicating the yogurt precursor according to a schedule to produce the yogurt having enhanced consistency to approximate a “Greek-style” yogurt.

2. The method for making the yogurt of claim 1, wherein a duration of the fermentation period is 12 to 18 hours.

3. The method for making the yogurt of claim 2, wherein the duration of the fermentation period is 15 to 16 hours.

4. The method for making the yogurt of claim 1, wherein maintaining the yogurt precursor at the fermentation temperature during the fermentation period includes maintaining the yogurt precursor at a temperature of 105 to 115° F.

5. The method for making the yogurt of claim 4, wherein maintaining the yogurt precursor at the fermentation temperature during the fermentation period includes maintaining the yogurt precursor at a temperature of 108° F. to 112° F.

6. The method for making the yogurt of claim 5, wherein maintaining the yogurt precursor at the fermentation temperature during the fermentation period includes maintaining the yogurt precursor at a temperature of 110° F.

7. The method for making the yogurt of claim 1, further comprising adding the live culture to the liquid milk product to make the yogurt precursor.

8. The method for making the yogurt of claim 7, further comprising, prior to adding the live culture to the liquid milk product:
heating the liquid milk product to an elevated temperature to kill undesirable microorganisms; and
reducing the elevated temperature to the fermentation temperature and maintaining the fermentation temperature;
wherein the step of adding the live culture occurs after the temperature is reduced to the fermentation temperature.

9. The method for making the yogurt of claim 8, wherein heating the liquid milk product to the elevated temperature includes heating the liquid milk product to within 20° F. of a boiling temperature of the liquid milk product.

10. The method for making the yogurt of claim 9, wherein heating the liquid milk product to the elevated temperature includes heating the liquid milk product to 200° F.

11. The method for making the yogurt of claim 8, wherein heating the liquid milk product to the elevated temperature includes heating the liquid milk product to a peak temperature below a full boil.

12. The method for making the yogurt of claim 1, further comprising:
introducing the liquid milk product to a fermentation vessel.

13. The method for making the yogurt of claim 12, wherein introducing the liquid milk product to the fermentation vessel includes introducing whole milk to the fermentation vessel.

14. The method for making the yogurt of claim 12, wherein introducing the liquid milk product to the fermentation vessel includes introducing 2% milk to the fermentation vessel.

15. The method for making the yogurt of claim 12, wherein introducing the liquid milk product to a fermentation vessel includes adding liquid milk and a quantity of powdered milk to the fermentation vessel.

16. The method for making the yogurt of claim 1, wherein sonicating the yogurt precursor according to the schedule includes sonicating the yogurt precursor according to a predetermined schedule.

17. The method for making the yogurt of claim 1, wherein sonicating the yogurt precursor includes:
applying a series of at least two pulse periods having respective pulse period durations, the at least two pulse periods being separated by at least one quiescent period having a quiescent duration.

18. The method for making the yogurt of claim 17, wherein applying the series of at least two pulse periods includes applying a first pulse period having a first pulse period duration of approximately 1 hour, the first pulse period starting within an hour after the live culture is added;
wherein a first at least one quiescent period duration is approximately a half hour; and
wherein applying the series of at least two pulse periods includes applying, after the first at least one quiescent period ends, a second pulse period having a second pulse period duration of approximately a half hour.

19. The method for making the yogurt of claim 17, wherein applying the series of at least two pulse periods includes applying, after a second pulse period and following a second quiescent period having a duration of between six and twelve hours, a third pulse period having a third pulse period duration of approximately 1 hour.

20. The method for making the yogurt of claim 19, further comprising:
maintaining a third quiescent period of between two and eight hours after the third pulse period.

21. The method for making the yogurt of claim 1, further comprising, after the fermentation period and after sonication, refrigerating the yogurt.

22. The method for making the yogurt of claim 1, wherein sonicating the yogurt precursor includes sonicating the yogurt precursor at a frequency of 40 KHz.
